(19) United States
(12) Patent Application Publication
(10) Pub. No.: US 2008/0313603 A1
(43) Pub. Date: Dec. 18, 2008

(54) User interface archive

(76) Inventor: Christian Denkel, Karlsruhe (DE)

Correspondence Address: BRAKE HUGHES BELLERMANN LLP, C/O INTELLEVATE, P.O. BOX 52050, MINNEAPOLIS, MN, 55402, US

(21) Appl. No.: 11/811,977

(22) Filed: Jun. 13, 2007

(51) Int. Cl. G06F 17/30; G06F 9/44

(52) U.S. Cl. 717/106; 707/10; 707/E17.01

(57) ABSTRACT

Source code associated with rendering an interface responsive to a user interaction may be stored in an archive, the source code including one or more network-resource locators identifying network locations of one or more resource files used in the rendering. The one or more resource files may be retrieved from the network locations based on the network-resource locators. The one or more retrieved resource files may be stored in the archive, wherein a local-resource locator identifies a local-resource location of each retrieved resource file in the archive. The network-resource locators may be replaced in the source code with the local-resource locators.

### TECHNICAL FIELD

This description relates to archiving interface data.

### BACKGROUND

As software applications, programs and interfaces become more powerful, they often also become more complex. The greater the complexity of an application or interface, the more difficult it may be to perform quality control with respect to the application or interface, and consequently, the more likely it may be that a user may notice an error or other unexpected response by the application or interface.

For example, the user may perform a sequence of steps using the interface (to the application) that results in a display error, such as a broken image to appear. However, it may be difficult for the user to accurately communicate exactly what sequence of steps were performed to generate the error. It may be helpful if the user had a way of tracking what actions were taken with respect to the interface and what was produced as a result of the actions.

### SUMMARY

In an example embodiment, a method is disclosed. Storing source code associated with rendering an interface responsive to a user interaction in an archive, the source code including one or more network-resource locators identifying network locations of one or more resource files used in the rendering. Retrieving the one or more resource files from the network locations based on the network-resource locators. Storing the one or more retrieved resource files in the archive, wherein a local-resource locator identifies a local-resource location of each retrieved resource file in the archive. Replacing, in the source code, the network-resource locators with the local-resource locators.

In another example embodiment, a system is disclosed. A request handler configured to determine user code based on a user interaction with a first interface. An archiving engine configured to store the user code and source code for rendering a second interface in response to the user code, in an archive, the source code including a network-resource locator identifying a network location of a resource used in the rendering of the second interface. A download engine configured to retrieve the resource from the network location based on the network-resource locator and store the retrieved resource in a local-resource location in the archive, the local-resource location being identified by a local-resource locator. Resource logic configured to associate the network-resource locator with the local-resource locator in the source code.

In another example embodiment a method for archiving a plurality of user interactions with an interface is disclosed. Repeating for each of the plurality of user interactions with the interface: storing user code associated with a first user interaction of the plurality of user interactions in an archive, storing source code generated in response to the first user interaction in the archive, wherein a first rendering of the interface based on the source code uses one or more resources, and downloading the one or more resources into the archive, wherein a second rendering of the interface based on the archive uses the one or more downloaded resources.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system that archives one or more interactions between a user and a user interface.

FIG. 2 is a flow diagram of an example information flow in the example system of FIG. 1, according to an example embodiment.

FIGS. 3A and 3B are block diagrams of example renderings of an interface.

FIG. 4 is a flowchart illustrating example operations of the system of FIG. 1.

FIG. 5 is a flowchart illustrating example operations of the system of FIG. 1.

### DETAILED DESCRIPTION

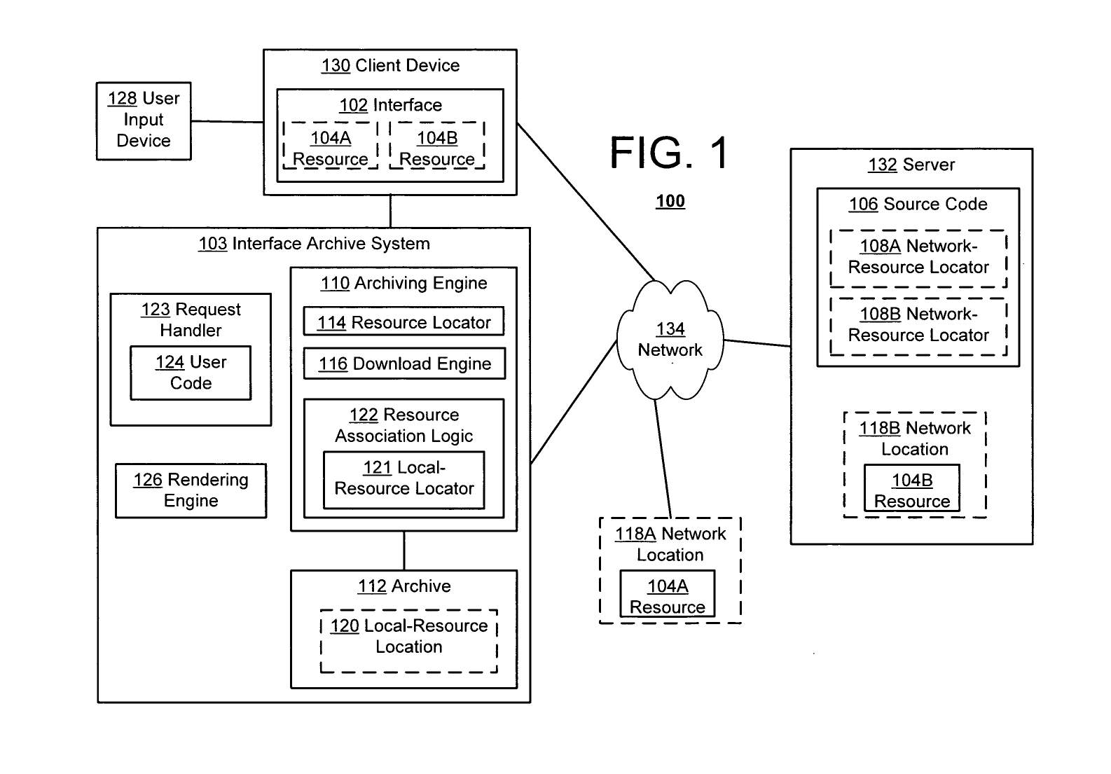

FIG. 1 is a block diagram of an example system 100 that archives one or more interactions between a user and a user interface. For example, a user may want to archive one or more interactions with the interface 102 that result in an error or other unexpected response by the interface 102. The system 100, in archiving the interactions, may download and store, in an archive 112, the code used in rendering the interface 102, any remote objects from remote locations called by the code, and modifications, changes or other updates to the code provided in response to the user interactions. The archive 112 may also include code or other descriptions associated with what actions the user performed with respect to the interface 102 causing the modified code to be provided.

Then for example, based on the archive 112, a developer or other support personnel may determine what actions the user performed on the interface 102, how the code changed responsive to the actions and what the interface 102 looked like after each interaction by the user, without having to access the remote locations (as the remote objects had been previously retrieved and stored in the archive 112). Being able to view the interface 102 as the user saw it, including the remote objects, may enable any errors or issues, identified by the user during interactions with the interface 102, to be more precisely and easily debugged by developers who may not otherwise have access to the remote objects stored in the remote locations.

The interface 102 may include a user interface for an application, program or other system, and may include a graphical user interface. During one or more interactions with the a user, the interface 102 may display or otherwise include design, format or functionality errors or other unexpected or unwanted responses to the user interactions. For example the interface 102 may include an interface for a customer relationship management (CRM) system including a welcome screen displaying buttons, graphics and text, whereby a user may perform one or more system functions by selecting the buttons. Then for example, upon receiving a button selection from the user, the interface 102 may provide a new or modified screen that has changed responsive to the interaction but in a way unexpected to the user.

One or more resources 104A and 104B may be used in a rendering of the interface 102. For example, the interface 102 may include in a display or rendering of the interface 102, including one or more screens associated with the interface, the resources 104A and 104B. The resources 104A and 104B may include any object used in rendering the interface 102. For example, the resources 104A and 104B may include word processing documents, graphics, spreadsheets, music, video and/or any other object or group of objects that may displayed on or in association with the interface 102. Or for example, the resources 104A and 104B may include an applet, plug-in or other program used by or associated with the interface 102. The resources 104A and 104B may include remote objects, stored or otherwise located in one or more remote locations that may need to be accessed prior to or during a rendering of the interface 102. For example, a banner or graphic to be displayed on the interface 102 may be stored on a network device.

As discussed above, a user may notice that the interface 102 may include an error or other unexpected response by the interface 102 to a user interaction. For example, the interface 102, when rendered in response to a button click may display a broken or missing image. The user may then want to report the issue to a help desk or system developer for resolution. Then for example, an offline interface archive system 103 may be used to record the interactions between the user and the interface 102 that resulted in the unexpected response. The recording may then be used by a developer or other support personnel to identify or otherwise debug the issue complained of by the user.

The interface archive system 103 may archive one or more interactions between a user and the interface 102. The interface archive system 103 may capture, for each of a plurality of interactions, what action a user took with respect to the interface 102 and how the interface 102 responded. For example, the interface archive system 103 may capture a button selection by the user and a rendering of the interface in response to the button selection. The interface archive system 103 also retrieves the resources 104A and 104B, used in rendering the interface 102, from the remote location(s) and stores them with the captured information. This may allow, for example, a developer to view the interface 102, as presented to the user during the course of the interactions, offline, e.g., without accessing the remote location(s), which may not be available to the developer, to download the resources 104A and 104B. The developer may then identify the location and/or cause of the error or unexpected response as experienced by the user, based on the captured data, providing what actions were taken by the user and how the interface 102 appeared in response to those actions.

The interface 102 may be rendered based on source code 106. The source code 106 may be code from which the interface 102 may be rendered, and may include such things as layout information, text, images, references to the remote locations of the resources 104A and 104B, and/or other display or activity objects associated with the interface 102. The source code 106 may include, for example, extensible markup language (XML), Java, HTML and/or other code used to render and/or generate at least a portion of the interface 102. The source code 106 may include updated or modified code generated in response to one or more user interactions with the interface 102, wherein the one or more actions by a user cause the interface 102 to change based on the updated source code 106.

One or more network-resource locators 108A and 108B, in the source code 106, may identify the remote locations of the corresponding to the one or more resources 104A and 104B. The network-resource locators 108A and 108B may include hyperlinks, addresses, or other descriptions of the location(s) of the resources 104A and 104B used in the interface 102. For example, the source code 106 may include the network-resource locators 108A and 108B as uniform resource locators (URLs) identifying the locations of the resources 104A and 104B on one or more devices or systems.

The interface archive system 103 may retrieve the resources 104A and 104B from the locations identified by the network-resource locators 108A and 108B and store the resources 104A and 104B in an archive 112 with the source code 106. The archive 112 may include one or more files storing information tracking interactions between a user and the interface 102 over a period of time. For example the archive 112 may include the source code 106 and resources 104A and 104B from which a first screen of the interface 102 is rendered. The archive 112 may also include information about how a user interacts with the first screen and the interface archive system 103 may capture and store in the archive 112 modified source code (e.g., 106) and resources (e.g., 104A and 104B) for rendering a second screen of the interface 102, responsive to the user interaction.

Prior to the interface archive system 103 downloading the resources 104A and 104B to the archive 112, a resource locator 114 may parse the source code 106 for the network-resource locators 108A and 108B. The resource locator 114 may parse or otherwise search the source code 106 for one or more standard formats associated with the network-resource locators 108A and 108B. For example, the network-resource locator 108A may include a uniform resource locator (URL) and begin with the string “http://” or “file:/”. Then for example, the resource locator 114 may parse the source code for strings beginning with “http://” or “file:/” to identify the network-resource locators 108A and 108B.

According to another example embodiment, the source code 106 may include one or more tags or labels associated with the network-resource locators 108A and 108B. For example, the source code 106 may include an <image> tag identifying the network-resource locator 108A, whereby the resource locator 114 may parse the source code 106 for any <image> tags that may exist. In other example embodiments, the resource locator 114 may include additional and/or different parsing and/or searching techniques.

Network locations 118A and 118B, as identified by the corresponding network-resource locators 108A and 108B in the source code 106, may be the locations where the resources 104A and 104B are stored or otherwise located. The network locations 118A and 118B may include one or more remote locations on one or more systems or networks where the resources 104A and 104B located. For example, by accessing the network location 118A, the resource 104A may be used in a rendering of the interface 102 based on the source code 106 (which includes the network-resource locator 108A).

A download engine 116 may download the resources 104A and 104B into the archive 112. For example, the download engine 116 may locate the resource 104A in the network location 118A based on the network-resource locator 108 in the source code 106, and download the resource 104A into a local-resource location 120 in or associated with the archive 112. Then for example, as discussed above, upon a rendering of the interface 102, based on the archive 112, the resource 104A will be available to complete the rendering as seen by a user.

The local-resource location 120 may include a memory location accessible to or within the archive 112 where the downloaded resources 104A and 104B may be stored. For example, the local-resource location 120 may include a file, directory, folder or other identifiable memory location.

A local-resource locator 121 may identify the local-resource location 120 including the resources 104A and 104B. The local-resource locator 121 may be similar to the network-resource locators 108A and 108B, except rather than identifying a remote or network location (e.g., 118A, 118B) of the resources 104A and 104B, the local-resource locator 121 may identify the local-resource location 120 where the resources 104A and 104B may have been downloaded and stored within the archive 112. It may be understood that even though only a single local-resource location 120 and single local-resource locator 121 are shown in the example of FIG. 1, that multiple local-resource locations 120 and multiple local-resource locators 121 may exist and correspond to the resources 104A and 104B downloaded into the archive 112.

Resource association logic 122 may record or otherwise determine an association between a network-resource locator 108A, 108B and the local-resource locator 120, for each resource 104A, 104B in the local-resource location 120. The association may provide that during a rendering of the interface 102 based on the archive 112, the source code 106 refers to the local-resource location 120 via the local-resource locator 121 rather than to the network location 118A via the network-resource locator 108A. For example, the resource association logic 122 may create or otherwise fill-in a resource look-up table (not shown), whereby during a rendering of the interface 102 based on the source code 106 stored in the archive 112, the network-resource locator 108A may be associated with the local-resource locator 121 which may be used by the local-resource location 120 of the resource 104A.

According to another example embodiment, the resource association logic 122 may replace the network-resource locators 108A and 108B with their corresponding local-resource locator 121. This replacement may be made prior to or during a rendering of the interface 102 and may be based on the source code 106 stored in the archive 112. In other example embodiments, the resource association logic 122 may use additional and/or different techniques for associating the downloaded resources 104A and 104B stored in the local-resource location 120 with the source code 106 in the archive 112.

A request handler 123 may determine or otherwise receive user code 124 associated with one or more user interactions with the interface 102. The user code 124 may include code generated based on and/or otherwise associated with one or more user interactions with the interface 102, including a description of which object(s) of the interface 102 were interacted with. For example, a user may click a button in location (X, Y) on the interface 102, whereby the user code 124 may reflect that the user clicked on the button in location (X, Y), where X and Y denote a two-dimensional coordinate system defining positions within the two-dimensional interface.

According to an example embodiment, the user code 124 may include XML code representing the user interaction. Then for example, the interface 102, or a device associated therewith, may generate the source code 106 for the rendering the interface 102, responsive to the user code 124. Thus the user code 124 may be generated for each user interaction that may change or otherwise cause a processing by the interface 102.

The request handler 123 may be configured to receive, generate or otherwise determine the user code 124. The request handler 123 may determine and store the user code 124 in the archive 112 in association with the source code 106 generated responsive to the user code 124. Then for example, a developer or other support personnel may determine, based on the archive 112, what interaction the user performed with respect to the interface 102, based on the user code 124, and how the interface 102 responded, based on the source code 106. This may allow the developer to step back and forth through a plurality of interface screens (rendered based on the source code 106 and resources 104A and 104B included in the archive 112) as captured by the interface archive system 103 during a period of time of user interaction and more easily identify any errors that may have occurred during the one or more user interactions.

A rendering engine 126 may render the interface 102 from the source code 106. For example, the rendering engine 126 may receive the source code 106 and may retrieve and/or access the resources 104A and 104B from the network locations 118A and 118B as determined from the network-resource locators 108A and 108B as included in the source code 106. Or for example, the rendering engine 126 may render screens of the interface 102 based the source code 106 stored in the archive 112, using the resources 104A and 104B from the local-resource location 120, and may allow a developer to step back and forth through the captured screens.

A user, however, may interact with the interface 102 rendered based on the source code 106 (and not the archive 112) via a user input device 128. The user input device 128 may include one or more devices configured to interact with the interface 102, including for example, a mouse, keyboard, and/or microphone and voice-recognition engine. As discussed above, the input received from the user input device(s) 128 may be used to generate the user code 124. According to an example embodiment, a user may use more than one user input device 128 to interact with the interface 102.

According to an example embodiment a client device 130 may provide the interface 102 to a user. For example, the client device 130 may include a display of one or more screens of the interface 102, as rendered based on the source code 106. The client device 130 may, according to an example embodiment, receive the source code 106 from a server 132 via a network 134.

The server 132 may include a network server or other device configured to receive the user code 124 and provide the source code 106. The server 132 may, for example, generate the source code 106 responsive to the user code 124. The server 132, as shown, may include the resource 104B in the network location 118B. However in other example embodiments, none or all the resources 104A and 104B may be stored on the server 132.

The network 134 may include any communications network configured to transfer files in between one or more devices. For example, the system 100 may, according to an example embodiment, be located on a single device, wherein the various components communicate via an internal network 134. Or for example, the client device 130 and the server 132 may exchange messages (e.g., user code 124 and source code 106) via the network. The download engine 116 may download the resources 104A and 104B via the network 134.

After a generation of the archive 112 by the interface archive system 103, a developer or other support professional may, without access to the network 134 and based on the archive 112, view the interface 102 as provided to a user in response to one or more user interactions. The developer may then more accurately determine where the error or other unexpected interface response experienced by the user may exist.

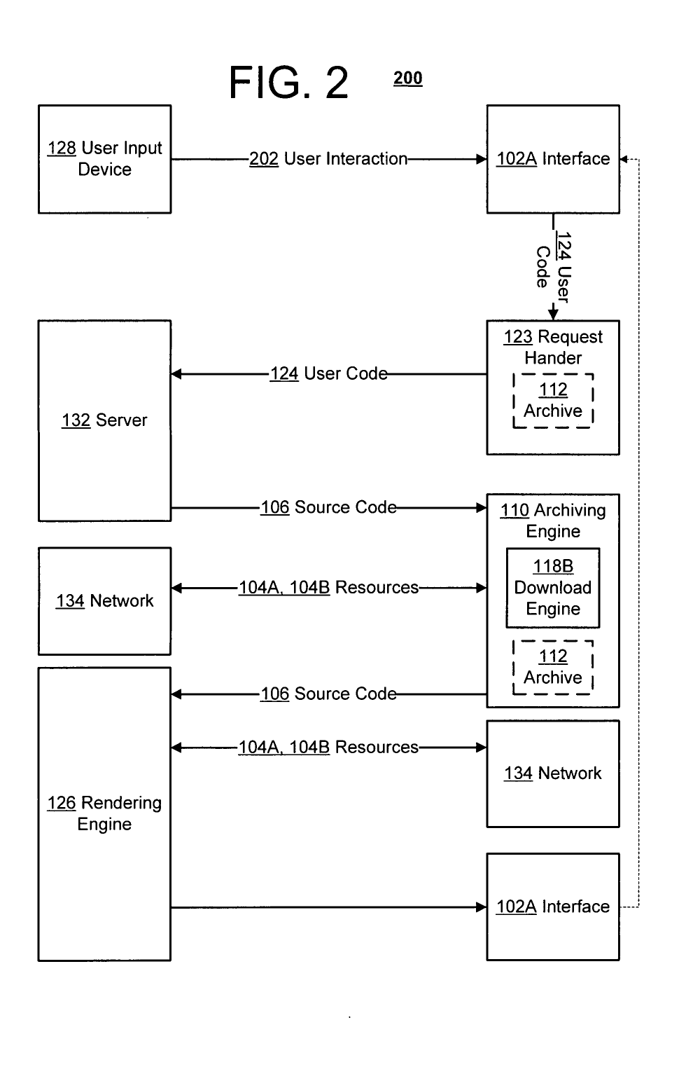

FIG. 2 is a flow diagram of an example information flow in the example system 100 of FIG. 1, according to an example embodiment. A user may, via the user input device 128, perform a user interaction 202 with an initial user interface 102A provided to the user. The user interaction 202 may include any interaction with the interface 102A anticipated to cause a response by the interface 102A. For example, the user interaction 202 may include a button click, menu selection, text entry, radio or check box selection or any other user interaction.

The interface 102A, having received the user interaction 202, may generate user code 124 associated with the received user interaction 202. The user code 124 may then be provided to the request handler 123. The request handler 123 may store the user code 124 in the archive 112 and provide the user code 124 to the server 132.

The server 132 may, upon receiving the user code 124, generate the source code 106 in response to the user code 124. The source code 106 may be used to render the user interface 102B, in response to the user interaction 202. The source code 106 may then be provided to the archiving engine 110.

The archiving engine 110 may store the received source code 106 in the archive 112. The download engine 116 may retrieve the resources 104A and 104B, as referenced in the source code 106, from one or more network locations (e.g., 118A and 118B) on the network 134 and store them in the archive 112.

The archiving engine 110 may provide the source code 106 to the rendering engine 126. The rendering engine 126 may then access the resources 104A and 104B, from the one or more network locations on the network 134, to render the interface 102B. Then the process may repeat, whereby the user may perform some action with regard to the interface 102B via the user input device 128.

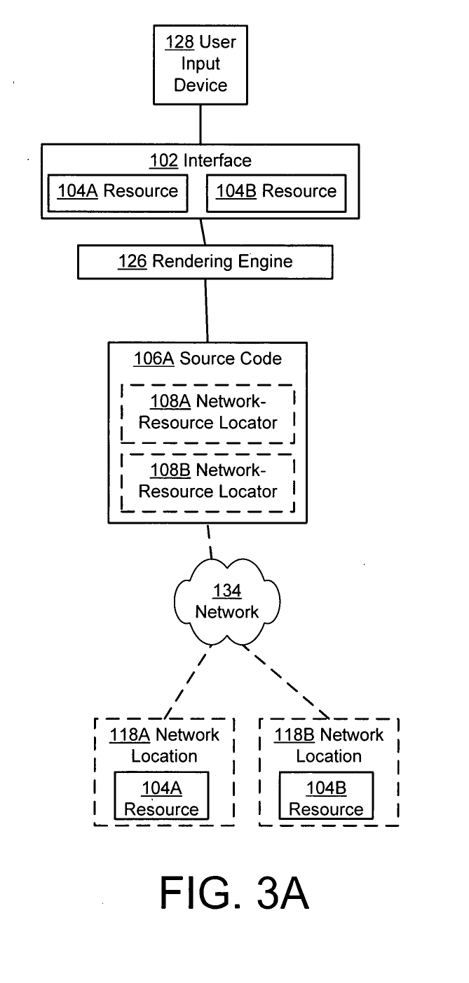

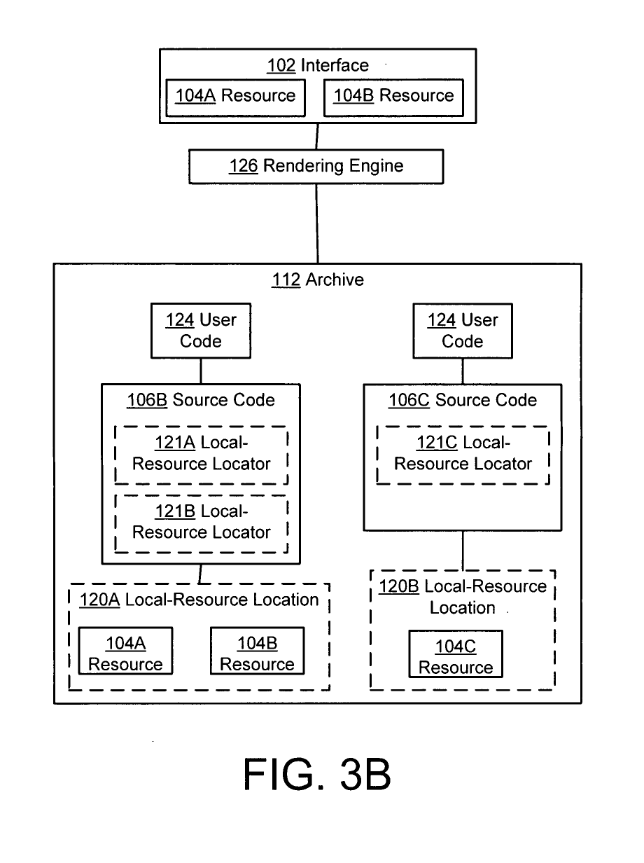

FIGS. 3A and 3B are block diagrams of example renderings of an interface 102. In FIG. 3A, the rendering engine 126 may render the interface 102 based on the source code 106A. The source code 106A may include network-resource locators 108A and 108B for locating the resources 104A and 104B on the network 134. Then for example, the rendering engine 126 may access the network locations 118A and 118B (via the network 134) to retrieve the resources 104A and 104B used in the rendering of the interface 102. Without access to the network 134, e.g., without access to the resources 104A and 104B from the network locations 118A and 118B, the rendering engine 126 may only be able to render a partial or broken interface. A user may then interact with the rendered interface 102 via the user input device 128, which may cause new source code to be generated and provided to the rendering engine 126.

In FIG. 3B, the rendering engine 126 may render the interface 102 based on the archive 112. The archive 112 may include source code 106B, which may correspond to the source code 106A of FIG. 3A, except that the source code 106B may include the local-resource locators 121A and 121B instead of the network-resource locators 108A and 108B. The rendering engine 126 may have access to the resources 104A and 104B in the local-resource location 120A, rather than needing to access the network 134 (as in FIG. 3A).

As discussed above, the system of FIG. 3B may be used by a developer or other support personnel to determine what action a user performed with regards to the interface 102, as captured in the user code 124A. Then for example, the developer may view the interface 102 provided in response to the first user action, as rendered based on the source code 106B.

The developer may then browse through other screens provided in response to other of the user's interactions with the interface 102. For example, the source code 106C may include source code for rendering the interface 102 as provided in response to the user code 124B. The archive 112 may, for example, contain multiple source codes (e.g., 106B, 106C) generated responsive to a plurality of user interactions (as captured in the user codes 124A and 124B), and the resources 104A, B and C used in rendering interface 102 based on the captured source codes.

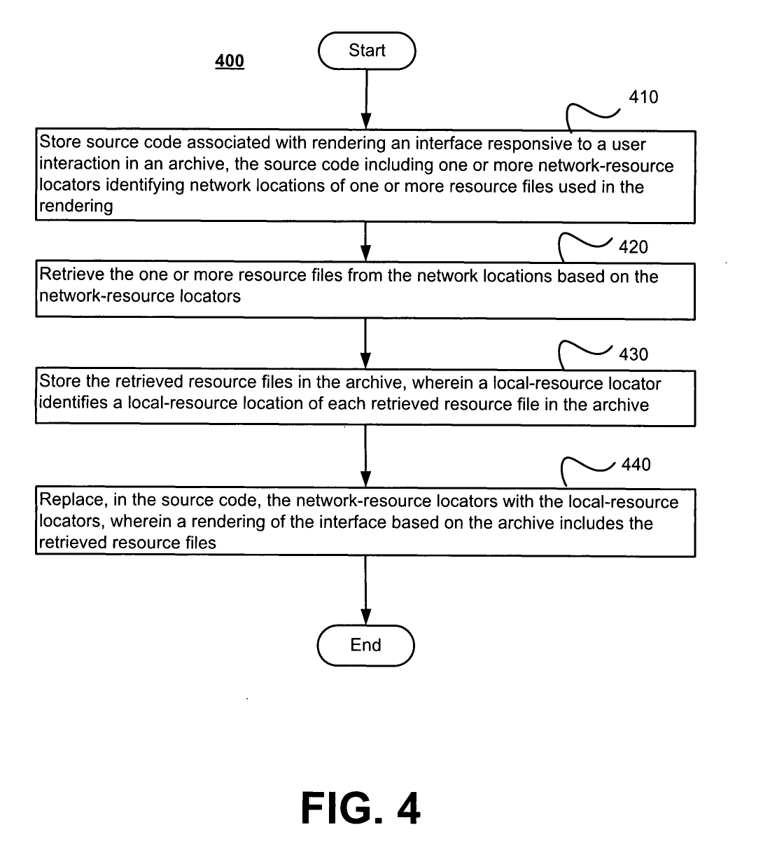

FIG. 4 is a flowchart 400 illustrating example operations of the system of FIG. 1. More specifically, FIG. 4 illustrates an operational flow 400 representing example operations related to interface archiving.

After a start operation, source code associated with rendering an interface responsive to a user interaction is stored in an archive, the source code including one or more network-resource locators identifying network locations of one or more resource files used in the rendering (410). For example, in FIG. 1, a user may interact with the interface 102 via the user input device 128, which may cause the user code 128 to be generated. The source code 106, including the network-resource locators 108A and 108B identifying the network locations 118A and 118B of the resources 104A and 104B, may then be generated responsive to the user code 124 and stored in the archive 112 by the archiving engine 110.

The one or more resource files are retrieved from the network locations based on the network-resource locators (420). For example, the resource locator 114 may identify the network-resource locators 108A and 108B within the source code 106 and the download engine 116 may retrieve the resources 104A and 104B from the network locations 118A and 118B.

The retrieved resource files are stored in the archive, wherein a local-resource locator identifies a local-resource location of each retrieved resource file in the archive (430). For example, the download engine 116 may store the resources 104A and 104B in the local-resource location 120 in the archive 112, as identified by the local-resource locator 121.

The network-resource locators are replaced, in the source code, with the local-resource locators, wherein a rendering of the interface based on the archive includes the retrieved resource files (440). For example, the resource association logic 122 may replace the network-resource locators 108A and 108B from the source code 106, as stored in the archive 112, with the local-resource locator 121 identifying the location of the resources in the local-resource location 120 within the archive 112.

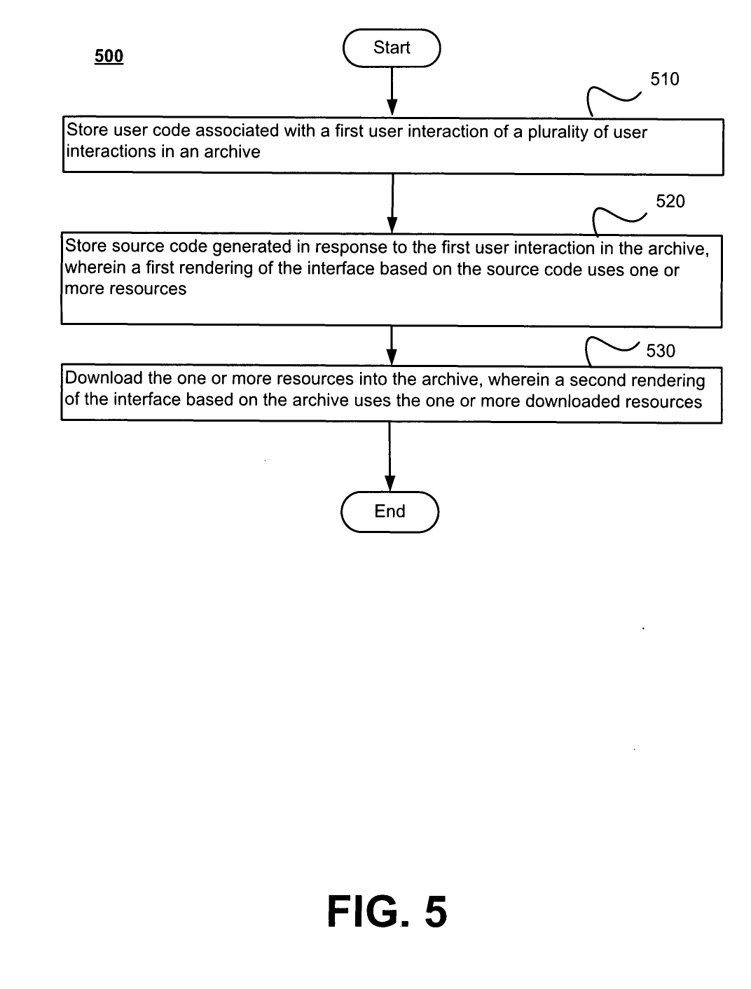

FIG. 5 is a flowchart 500 illustrating example operations of the system of FIG. 1. More specifically, FIG. 5 illustrates an operational flow 500 representing example operations related to interface archiving.

After a start operation, user code associated with a first user interaction of the plurality of user interactions is stored in an archive (510). For example, in FIG. 1, the request handler 123 may store the user code 124 in the archive 112.

Source code generated in response to the first user interaction is stored in the archive, wherein a first rendering of the interface based on the source code uses one or more resources (520). For example, the archiving engine 110 may store the source code 106 in the archive 112. Then for example, the rendering engine 126 may, during a rendering of the interface 102 based on the source code 106, retrieve or otherwise access the resources 104A and 104B from the network locations 118A and 118B.

The one or more resources are downloaded into the archive, wherein a second rendering of the interface based on the archive uses the one or more downloaded resources (530). For example, the download engine 116 may download the resources 104A and 104B into the archive 112. Then for example, the rendering engine 126, rendering the interface 102 based on the archive 112, may use the resources 104A and 104B as stored in the local-resource location 120 within the archive 112.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method comprising:
storing source code associated with rendering an interface responsive to a user interaction in an archive, the source code including one or more network-resource locators identifying network locations of one or more resource files used in the rendering;
retrieving the one or more resource files from the network locations based on the network-resource locators;
storing the one or more retrieved resource files in the archive, wherein a local-resource locator identifies a local-resource location of each retrieved resource file in the archive; and
replacing, in the source code, the network-resource locators with the local-resource locators.

2. The method of claim 1, further comprising:
generating user code based on the user interaction; and
storing the user code in the archive.

3. The method of claim 1 wherein storing the source code comprises:
capturing user code that is associated with the user interface and that is sent to a server configured to provide the source code responsive to the user code; and
storing the user code in the archive.

4. The method of claim 1 wherein storing the source code comprises receiving the source code associated with rendering the interface in response to the user interaction, wherein the interface changes responsive to the user interaction.

5. The method of claim 1 wherein storing the source code comprises storing an extensible markup language (XML) file associated with rendering the interface.

6. The method of claim 1 wherein storing the source code comprises receiving the source code including one or more uniform resource locators (URLs) identifying the network locations.

7. The method of claim 1 wherein retrieving the one or more resource files comprises downloading, from the one or more network locations, the one or more resource files based on the network-resource locators.

8. The method of claim 1 wherein replacing the network-resource locators with the local-resource locators comprises replacing a first network-resource locator identifying a first network location of a first resource with a first local-resource locator identifying a first local-resource location of the first resource.

9. The method of claim 1 wherein the replacing the network-resource locators with the local-resource locators comprises replacing, in the source code, the network-resource locators with the local-resource locators during a rendering of the interface based on the archive, wherein during the rendering, the local resource-locators are used in lieu of the network-resource locators.

10. The method of claim 1 further comprising:
rendering the interface based on the source code and retrieved one or more resource files stored in the archive.

11. A system comprising:
a request handler configured to determine user code based on a user interaction with a first interface;
an archiving engine configured to store the user code and source code for rendering a second interface in response to the user code, in an archive, the source code including a network-resource locator identifying a network location of a resource used in the rendering of the second interface;
a download engine configured to retrieve the resource from the network location based on the network-resource locator and store the retrieved resource in a local-resource location in the archive, the local-resource location being identified by a local-resource locator; and
resource logic configured to associate the network-resource locator with the local-resource locator in the source code.

12. The system of claim 11 wherein the request handler is configured to:
receive the user interaction with the first interface; and
generate the user code based on the user interaction.

13. The system of claim 11 wherein the archiving engine is configured to receive the source code from a server configured to generate the source code in response to the user code.

14. The system of claim 11 wherein the archiving engine is configured to store first source code used for rendering the first user interface in the archive.

15. The system of claim 11 wherein the resource logic is configured to replace the network resource-locator with the local resource-locator in the source code

16. The system of claim 11 further comprising a rendering engine configured to render the second interface based on the archive and using the retrieved resource stored in the local-resource location.

17. The system of claim 11 further comprising a rendering engine configured to render a plurality of interfaces based on the source code stored in the archive, wherein the plurality of interfaces are associated with a plurality of user interactions with the plurality of interfaces.

18. A method for archiving a plurality of user interactions with an interface comprising:
repeating for each of the plurality of user interactions with the interface:
storing user code associated with a first user interaction of the plurality of user interactions in an archive;
storing source code generated in response to the first user interaction in the archive, wherein a first rendering of the interface based on the source code uses one or more resources; and
downloading the one or more resources into the archive, wherein a second rendering of the interface based on the archive uses the one or more downloaded resources.

19. The method of claim 18 wherein storing the source code comprises storing the source code, generated in response to the first user interaction, in the archive, wherein the interface changes responsive to the first user interaction.

20. The method of claim 18 wherein the first rendering of the interface and the second rendering of the interface are identical.
